(19) United States
(12) Patent Application Publication
(10) Pub. No.: US 2015/0219232 A1
(43) Pub. Date: Aug. 6, 2015

(54) MEMBRANE STYLE EXCESS FLOW VALVE

(71) Applicant: BRASSCRAFT MANUFACTURING COMPANY, Novi, MI (US)

(72) Inventors: Jesus R. Dominguez, Plymouth, MI (US); Joseph P. Schutte, Westland, MI (US); David C. Tisch, Ferndale, MI (US)

(73) Assignee: BRASSCRAFT MANUFACTURING COMPANY, Novi, MI (US)

(21) Appl. No.: 14/169,178

(22) Filed: Jan. 31, 2014

(51) Int. Cl. F16K 17/24

(52) U.S. Cl. CPC F16K 17/24

(57) ABSTRACT

An assembly for limiting excess flow includes a housing having an internal bore defined by a first diameter, a seat held fixed within the internal bore, and a diaphragm defined by a second diameter that is less than the first diameter. The seat provides a sealing surface and the diaphragm is coupled to the seat by at least one leg. The diaphragm is spaced apart from the sealing surface during normal flow conditions and is in engagement with the sealing surface when a predetermined flow condition is exceeded.

### BACKGROUND OF THE INVENTION

The present invention generally relates to an excess flow valve that permits fluid flow through a flow line if the flow is below a predetermined flow rate but minimizes the flow if the flow rate rises above the predetermined limit to prevent uncontrolled flow or discharge of fluids.

Excess flow valves are typically used in a capsule to facilitate its installation in various flow lines, fittings, pipe systems, appliances and the like. The excess flow valve acts in response to a high or a low differential pressure between the upstream pressure and downstream pressure of the capsule. In one known configuration, the excess flow valve is comprised of four components including a housing, a seat, a valve plate or body, and a spring or magnet to bias the valve plate. The capsule may be inserted in various flow passageways including a valve body, a connector fitting, a hose fitting, a pipe nipple, a tube, a male iron pipe (MIP), a female iron pipe (FIP), an appliance and other similar installations to provide excess flow protection.

These spring and magnet configurations can be disadvantageous from a cost and assembly perspective due to the number of components. The magnet is especially costly and difficult to procure. Further, the magnet poses constraints on the design of the capsule and excess flow valve that make it difficult to lower cost and provide improvements.

### SUMMARY OF THE INVENTION

According to one exemplary embodiment, an assembly for limiting excess flow includes a housing having an internal bore defined by a first diameter, a seat held fixed within the internal bore, and a diaphragm defined by a second diameter that is less than the first diameter. The seat provides a sealing surface and the diaphragm is coupled to the seat by at least one leg. The diaphragm is spaced apart from the sealing surface during normal flow conditions and is in engagement with the sealing surface when a predetermined flow condition is exceeded.

In another embodiment according to the previous embodiment, the at least one leg comprises a plurality of legs that are circumferentially spaced apart from each other.

In another embodiment according to any of the previous embodiments, the legs are moveable between a first position during normal flow conditions and are collapsed to a second position when the predetermined flow condition is exceeded.

In another embodiment according to any of the previous embodiments, the diaphragm comprises a solid body having an upstream side and a downstream side, and wherein the legs have a first end attached to the downstream side and a second end attached to the seat.

In another embodiment according to any of the previous embodiments, the second diameter comprises an outermost diameter of the solid body and wherein the solid body is defined by a minimum diameter at the downstream side with a tapered surface extending between the outermost diameter and the minimum diameter.

In another embodiment according to any of the previous embodiments, the seat comprises a rigid ring body having an upstream end face and a downstream end face, the ring body having an inner opening that is aligned within the internal bore, and wherein the downstream end face is seated on the shoulder with the sealing surface comprising a tapered surface extending radially inward from the upstream end face.

In another embodiment according to any of the previous embodiments, the diaphragm includes an outermost peripheral edge that defines the second diameter and wherein the inner opening of the seat defines a surface that extends from a downstream end of the tapered surface to the downstream end face of the seat, and wherein during normal flow conditions fluid flows around the outermost peripheral edge of the diaphragm and through a gap formed between the seat and the diaphragm, and then through openings between the legs and through the inner opening of the ring body.

In another embodiment according to any of the previous embodiments, when the predetermined flow condition is exceeded, the diaphragm engages the tapered surface to prevent flow through the inner opening of the ring body.

In another embodiment according to any of the previous embodiments, the ring body includes a plurality of recesses that receive ends of the legs.

In another embodiment according to any of the previous embodiments, the recesses comprise at least partially curved surfaces, and wherein the ends of the legs comprise enlarged bulbous ends that engage the curved surfaces.

According to another exemplary embodiment, a method of forming an excess flow valve includes molding first and second housing pieces, connecting the first and second housing pieces together to define an internal bore, coupling a diaphragm to a seat with one or more legs such that the diaphragm is moveable relative to the seat, and fixing the seat within the internal bore.

In another embodiment according to any of the previous embodiments, additional steps include molding the first and second housing from a plastic material and forming the at least one leg from a flexible material.

In another embodiment according to any of the previous embodiments, additional steps include forming a plurality of recesses in the seat and inserting a downstream end of each leg into one recess.

These and other features of the present invention can be best understood from the following specification and drawings, the following of which is a brief description.

### BRIEF DESCRIPTION OF THE DRAWINGS

FIG. 1 shows a cross-section view of an excess flow valve in a fitting when in an open position.

FIG. 2 shows the excess flow valve of FIG. 1 in a closed position.

FIG. 3 is an exploded view of the excess flow valve of FIG. 1.

FIG. 4 is a perspective side view of the excess flow valve of FIG. 3 when assembled.

FIG. 5 is an end view of FIG. 4.

FIG. 6 is a cross-section of the excess flow valve when assembled.

FIG. 7 is a magnified view of a recess that receives a leg of the excess flow valve.

FIG. 8 is a magnified cross-section view of a leg received with the recess.

### DETAILED DESCRIPTION

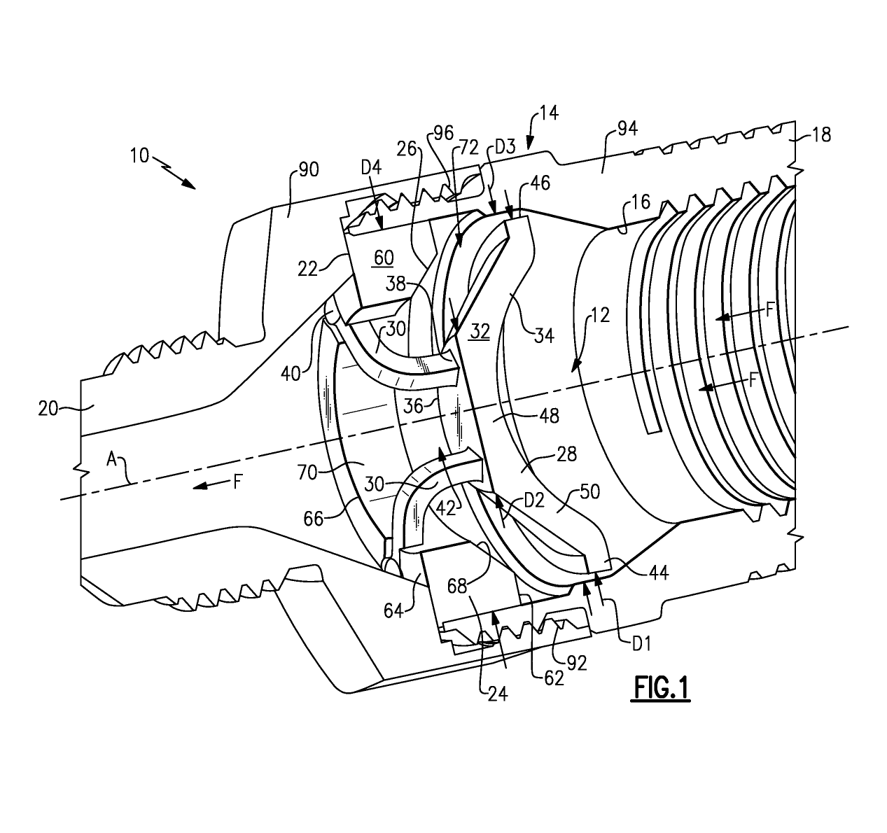

FIG. 1 shows a fitting 10 and an excess flow valve 12. The fitting 10 can carry different fluids, such as natural gas, or other gases or liquids for example. In one example configuration, the fitting 10 is configured to couple a fluid supply line to an appliance (not shown).

The fitting 10 includes a housing 14 having an internal bore 16 defining a central axis A and extending from an upstream end 18 to a downstream end 20. The bore 16 provides a shoulder 22 within the internal bore 16. A seat 24 is held fixed within the internal bore 16 and provides a sealing surface 26. A diaphragm 28 is coupled to the seat 24 by one or more legs 30. The diaphragm 28 is spaced apart from the sealing surface 26 during normal flow conditions and is in engagement with the sealing surface 26 when a predetermined flow condition is exceeded. This will be discussed in greater detail below.

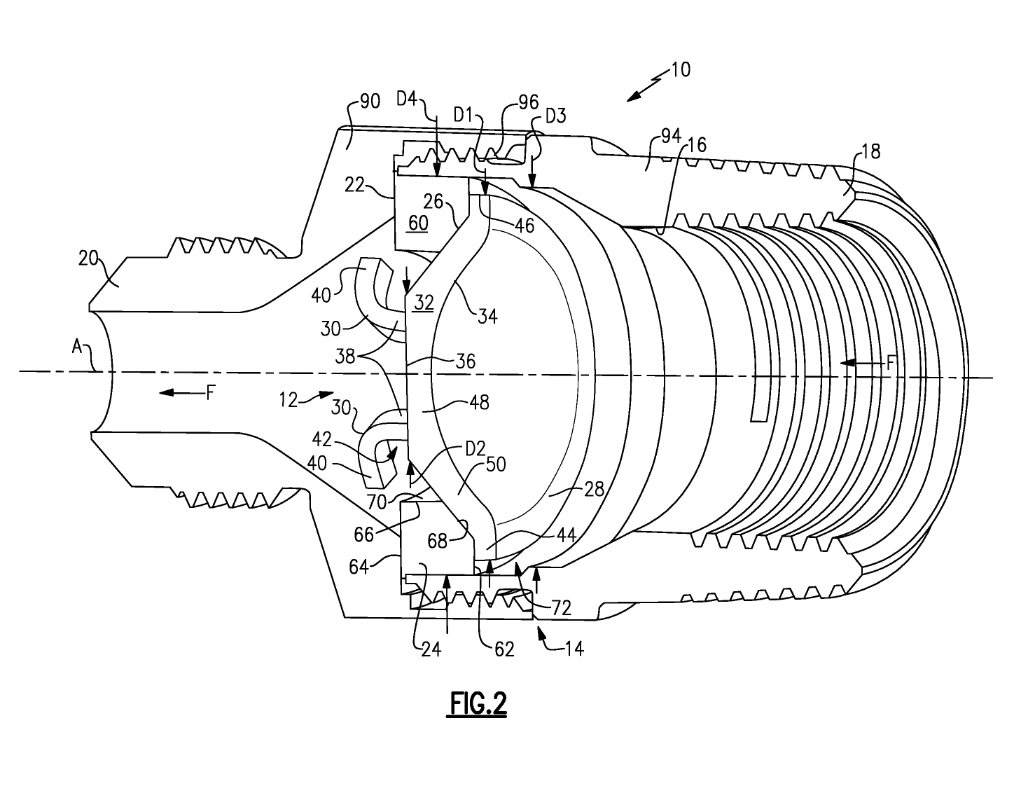

The diaphragm 28 comprises a solid body 32 having an upstream side 34 and a downstream side 36. The legs 30 have a first end 38 attached to the downstream side 36 and a second end 40 attached to the seat 24. The legs 30 are circumferentially spaced apart from each other about the central axis A. Gaps or openings 42 are formed between adjacent legs 30. The legs 30 are moveable between a first position (FIG. 1) during normal flow conditions and are collapsed to a second position (FIG. 2) when the predetermined flow condition is exceeded.

The solid body 32 comprises a shuttle portion of the excess flow valve 12 that is naturally positioned to allow for flow through the valve 12 during normal flow conditions. When a certain flow pressure is reached, i.e. the predetermined flow condition is exceeded, the pressure on the shuttle portion overcomes the resistance of the legs 30 and the shuttle portion will press against the sealing surface 26 of the seat 24 to prevent fluid from being released to the external environment in an excess flow condition. After the pressure is equalized on both sides of the shuttle portion, the resilient force of the legs 30 causes the shuttle portion to return to the original position such that fluid can again flow through the valve 12.

In one example, the solid body 32 comprises a cup-shape with the upstream side 34 comprising a concave surface against which flow pressure F is exerted. The solid body 32 has a lip 44 that extends about the central axis A to form a peripheral edge 46 of the solid body 32. The solid body 32 on the upstream side 34 curves inwardly from the lip 44 to a bottom 48 of the cup-shape. The peripheral edge 46 defines a maximum of an outermost diameter D1 of the solid body 32. The bottom 48 defines a minimum diameter D2 of the solid body 32. The solid body 32 includes a tapered surface portion 50 that extends inwardly from the downstream side of the lip 44 toward the bottom 48 at the minimum diameter.

In one example, the first ends 38 of the legs 30 are attached to a downstream side of the bottom 48 of the solid body 32, and the legs 30 are curved in a radially inwardly direction during normal flow conditions as shown in FIG. 1. The legs 30 are formed from a flexible material such that the legs 30 are capable of holding the solid body 32 away from the seat 24 during normal flow conditions. During an excess flow condition, the resilient upstream biasing force of the legs 30 is overcome and the legs 30 bend further inwardly toward each other to pull the solid body 32 in a downstream direction until the tapered surface portion 50 is in sealing engagement with the sealing surface 26. When pressures eventually equalize on both sides of the solid body 32, the resilient force of the legs 30 allows the legs 30 to push the solid body 32 in an upstream direction and out of engagement with the seat 24.

As shown in FIG. 1, the internal bore 16 defined by a diameter D3 at a portion that is aligned with the lip 44 during normal flow conditions. Diameter D3 is greater than the outermost diameter D1 of the diaphragm 28. The internal bore 16 is defined by another diameter D4 at a downstream location that receives the seat 24. D4 is greater than D3. The shoulder 22 defines an abutment surface against which the seat 24 is held fixed in a press-fit.

In one example, the seat 24 comprises a rigid ring body 60 having an upstream end face 62 and a downstream end face 64. The ring body 60 has an inner opening 66 that is aligned with the internal bore 16. In one example, the inner opening 66 is concentric with the axis A. The downstream end face 64 is seated directly on the shoulder 22 with the sealing surface 26 comprising a tapered surface 68 that extends in a radially inward direction from the upstream end face 62. The lip 44 of the solid body 32 is seated against the upstream end face 62 during an excess flow condition.

The inner opening 66 of the seat 24 defines a surface 70 that extends from a downstream end of the tapered surface 68 to the downstream end face 64. During normal flow conditions fluid flows around the outermost peripheral edge 46 of the lip 44 of the diaphragm 28 and through a gap 72 formed between the seat 24 and the diaphragm 28. The fluid then flows through the openings 42 formed between adjacent legs 30 and through the inner opening 66 of the ring body 60 to exit the downstream end 20 of the housing 14. When the predetermined flow condition is exceeded, such as during an excess flow condition, the diaphragm 28 engages the tapered surface 68 to prevent flow through the inner opening 66 of the ring body 60.

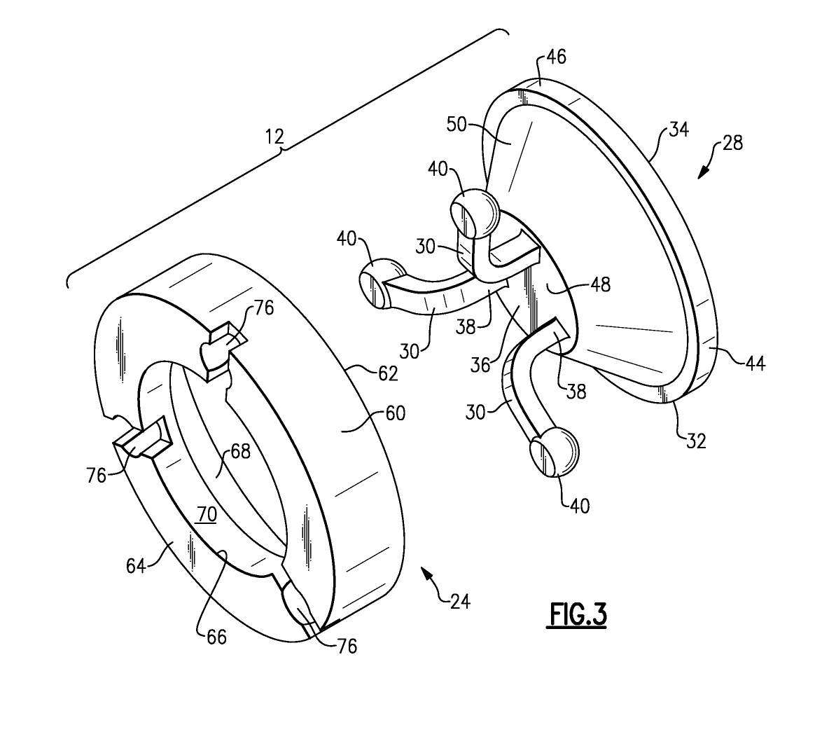

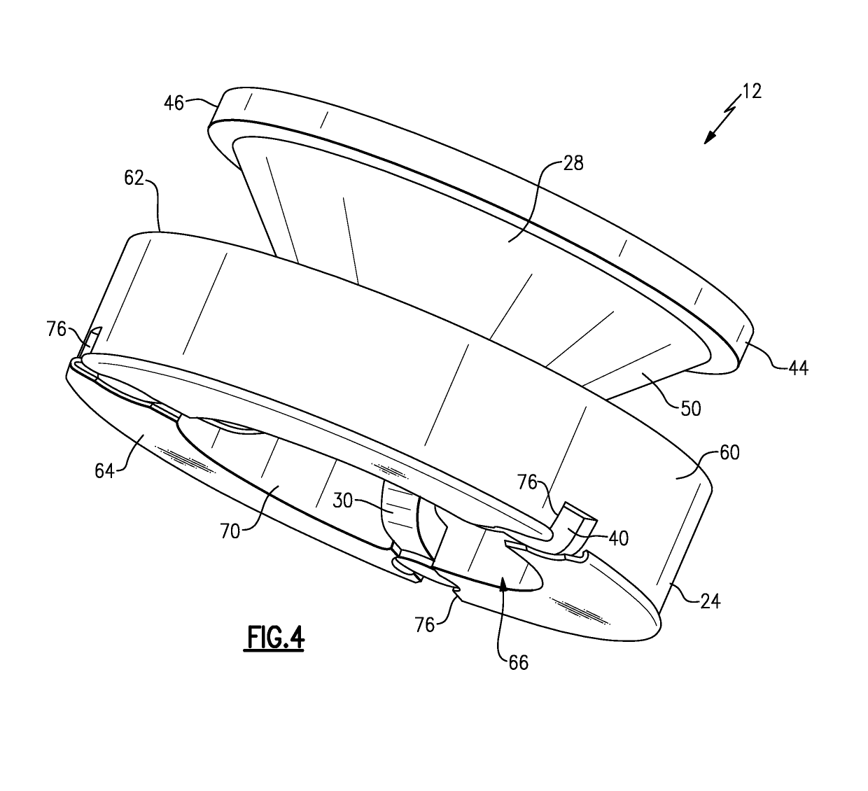

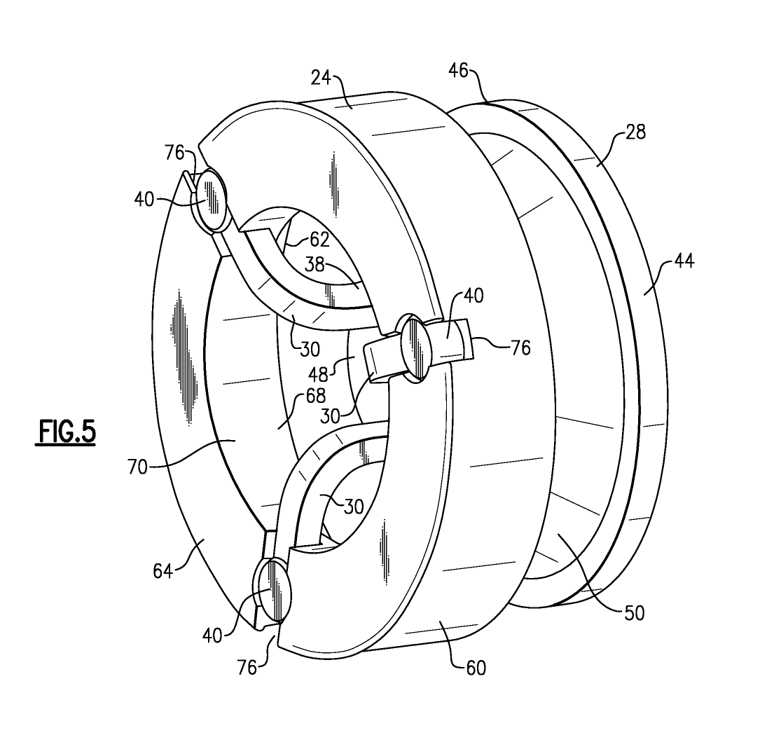

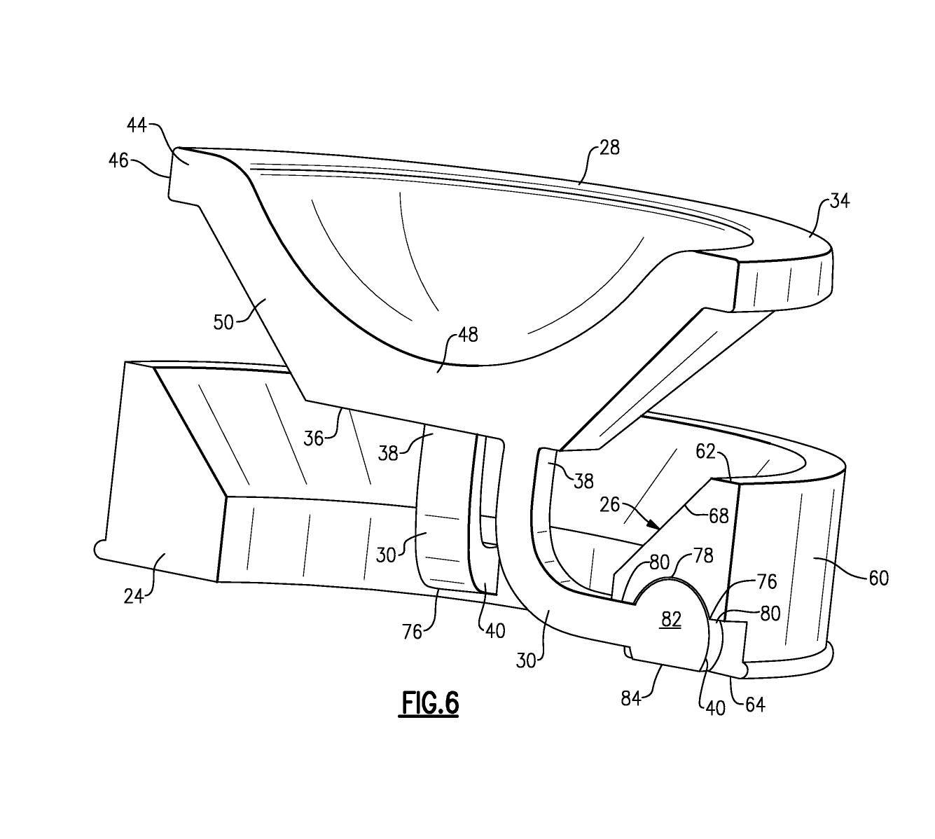

As shown in FIG. 3, the ring body 60 includes a plurality of recesses 76 that form attachment interfaces for the legs 30. As shown in FIGS. 4-6 the second ends 40 of the legs 30 are received within the recesses 76.

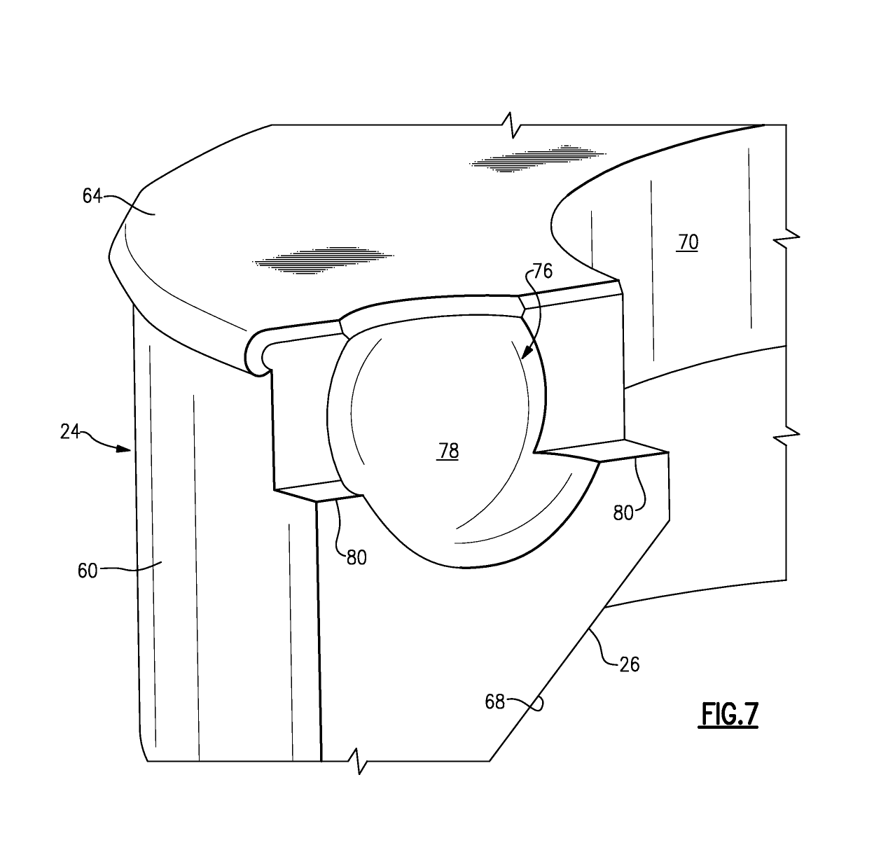

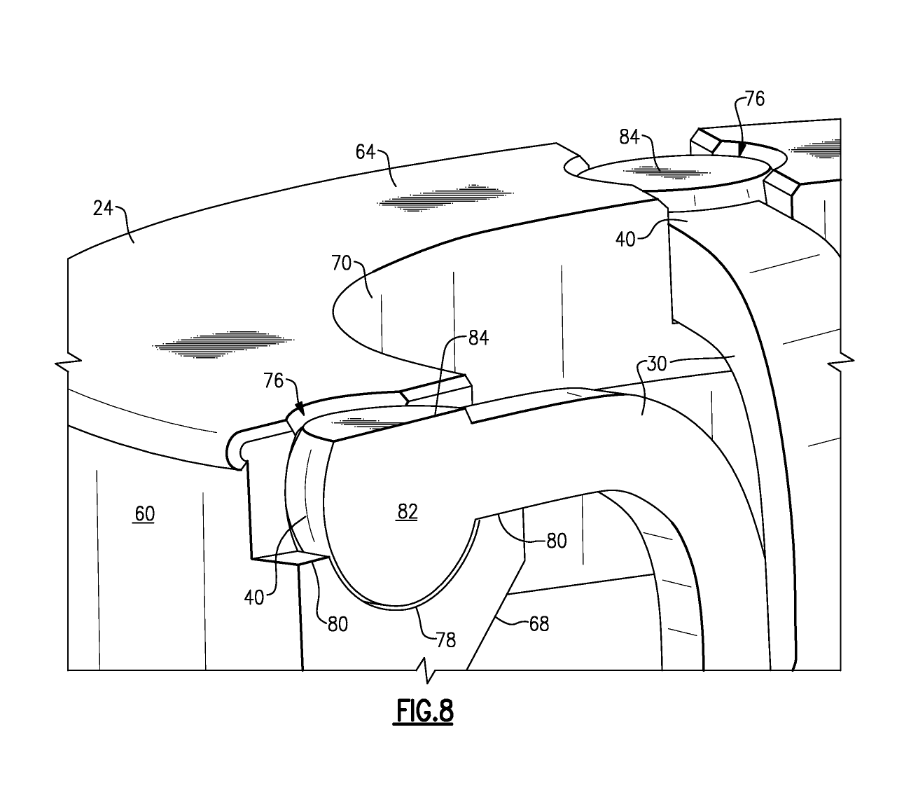

FIG. 7 shows a magnified view of one of the recesses 76. The recesses 76 are open to the downstream end face 64. Each recess 76 includes a curved surface portion 78 that is positioned between a pair of linear surface portions 80. As shown in FIG. 8, the second end 40 of the leg 30 includes an enlarged bulbous portion 82 that has a greater cross-sectional area than the leg 30. In the example shown, the legs 30 have a square or rectangular shape; however, other cross-sectionals shapes could also be used. When installed, each bulbous portion 82 engages the curved surface portions 78 of the recesses 76. In one example, one side of the bulbous portion 82 is truncated 84 such that the bulbous portion 82 does not extend outwardly of the ring body 60 at the downstream end face 64 to further facilitate flow.

In one example, the housing 14 (see FIGS. 1-2) comprises a first piece 90 having a first attachment interface 92 and a second piece 94 having a second attachment interface 96 that cooperates with the first attachment 92 interface to selectively connect the first 90 and second 94 pieces together. In one example, the first 92 and second 96 attachment interfaces comprise threaded attachment interfaces.

One exemplary method of forming the excess flow valve 12 includes the steps of molding the first 90 and second 94 housing pieces, connecting the first 90 and second 94 housing pieces together to define the internal bore 16, coupling the diaphragm 28 to the seat 24 with one or more legs 30 such that the diaphragm 28 is moveable relative to the seat 24, and fixing the seat 24 within the internal bore 16.

In one example, the method includes the steps of molding the first 90 and second 94 housings from a plastic material and forming the legs 30 from a flexible material.

The subject invention offers several advantages over prior designs. The subject invention offers a reduction in components as compared to a four-piece configuration (eliminating a brass fitting, a brass seat, a plate and replacing a plastic housing, for example), resulting in a simpler design. A two-piece configuration is provided with the valve being co-molded or molded in during a two-shot molding process. The legs of the diaphragm have a smaller cross-sectional area as compared to the previous plastic housing, which allows for more efficient flow through the valve. Also, the diaphragm can be manufactured from an elastomer or thermoplastic material with similar properties, with a plastic or rigid base for stability during assembly.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

What is claimed is:

1. An assembly for limiting excess flow comprising:
a housing having an internal bore defined by a first diameter;
a seat held fixed within the internal bore, the seat providing a sealing surface; and
a diaphragm defined by a second diameter that is less than the first diameter, the diaphragm being coupled to the seat by at least one leg, and wherein the diaphragm is spaced apart from the sealing surface during normal flow conditions and is in engagement with the sealing surface when a predetermined flow condition is exceeded.

2. The assembly of claim 1 wherein the at least one leg comprises a plurality of legs that are circumferentially spaced apart from each other.

3. The assembly of claim 2 wherein the legs are moveable between a first position during normal flow conditions and are collapsed to a second position when the predetermined flow condition is exceeded.

4. The assembly of claim 2 wherein the diaphragm comprises a solid body having an upstream side and a downstream side, and wherein the legs have a first end attached to the downstream side and a second end attached to the seat.

5. The assembly of claim 4 wherein the solid body comprises a cup-shape with the upstream side comprising a concave surface against which flow pressure is exerted.

6. The assembly of claim 4 wherein the second diameter comprises an outermost diameter of the solid body and wherein the solid body is defined by a minimum diameter at the downstream side with a tapered surface extending between the outermost diameter and the minimum diameter.

7. The assembly of claim 6 wherein the legs are curved in a radially inwardly direction during normal flow conditions.

8. The assembly of claim 2 wherein the seat comprises a rigid ring body having an upstream end face and a downstream end face, the ring body having an inner opening that is aligned within the internal bore, and wherein the downstream end face is seated on the shoulder with the sealing surface comprising a tapered surface extending radially inward from the upstream end face.

9. The assembly of claim 8 wherein the diaphragm includes an outermost peripheral edge that defines the second diameter and wherein the inner opening of the seat defines a surface that extends from a downstream end of the tapered surface to the downstream end face of the seat, and wherein during normal flow conditions fluid flows around the outermost peripheral edge of the diaphragm and through a gap formed between the seat and the diaphragm, and then through openings between the legs and through the inner opening of the ring body.

10. The assembly of claim 9 wherein, when the predetermined flow condition is exceeded, the diaphragm engages the tapered surface to prevent flow through the inner opening of the ring body.

11. The assembly of claim 8 wherein the ring body includes a plurality of recesses that receive ends of the legs.

12. The assembly of claim 11 wherein the recesses comprise at least partially curved surfaces, and wherein the ends of the legs comprise enlarged bulbous ends that engage the curved surfaces.

13. The assembly of claim 1 wherein the housing comprises a first piece having a first attachment interface and a second piece having a second attachment interface that cooperates with the first attachment interface to selectively connect the first and second pieces together.

14. The assembly of claim 13 wherein the first and second attachment interfaces comprise threaded attachment interfaces.

15. A method of forming an excess flow valve comprising:
molding first and second housing pieces;
connecting the first and second housing pieces together to define an internal bore;
coupling a diaphragm to a seat with at least one leg such that the diaphragm is moveable relative to the seat; and
fixing the seat within the internal bore.

16. The method of claim 15 including molding the first and second housing from a plastic material and forming the at least one leg from a flexible material.

17. The method of claim 15 wherein the at least one leg comprises a plurality of legs, and including forming a plurality of recesses in the seat and inserting a downstream end of each leg into one recess.

18. The method of claim 17 including forming a tapered sealing surface on the seat that is configured to engage a downstream surface of the diaphragm when a predetermined flow condition is exceeded.
